(19) United States
(12) Patent Application Publication
(10) Pub. No.: US 2005/0149770 A1
(43) Pub. Date: Jul. 7, 2005

(54) Adjustable active voltage positioning system

(76) Inventors: Henry W. Koertzen, Hillsboro, OR (US); Frank Kern, Bellingham, WA (US)

Correspondence Address: BUCKLEY, MASCHOFF, TALWALKAR LLC, 5 ELM STREET, NEW CANAAN, CT, 06840, US

(21) Appl. No.: 10/751,372

(22) Filed: Jan. 5, 2004

(51) Int. Cl. G06F 1/26

(52) U.S. Cl. 713/300

(57) ABSTRACT

A system may include reception of a first signal representing a first supply voltage value associated with a first supply current value, and representing a second supply voltage value associated with a second supply current value. Some embodiments further include generation of a supply voltage signal having a voltage value based at least in part on the first signal.

### BACKGROUND

An integrated circuit (IC) may be designed to operate in conjunction with a specified range of supply voltages. Supply voltages that fall outside this range may cause speed path problems and/or IC degradation. A voltage regulator is often used to generate an appropriate supply voltage for use by an IC.

A supply voltage generated by a voltage regulator may exhibit transients due to changes in load conditions. For example, an IC draws a maximum amount of current when exiting an idle state, which usually causes the supply voltage to droop. A voltage regulator may therefore be designed to output a “static” supply voltage that falls near the middle of the range of supply voltages specified for a particular IC. As a result, most or all voltage transients (e.g., droops and spikes) remain within the range of specified supply voltages.

Decreasing the static supply voltage may decrease the amount of power consumed by the above-described system. In one method, the static supply voltage is decreased and the magnitude of supply voltage droop is also decreased such that any transient voltages remain within the specified voltage range. The magnitude of the supply voltage droop may be decreased by adding bulk capacitors to the system. Such bulk capacitors, however, may require significant additional cost and board space.

Adaptive voltage positioning may also be used to decrease power consumption while addressing transient voltages. Using adaptive voltage positioning, a voltage regulator sets the static supply voltage at a first level if it senses a low supply current and sets the static supply voltage at a second level if it senses a higher supply current, with the second level being lower than the first level. The probable magnitude of a voltage droop decreases at higher supply currents, therefore the static supply voltage may be set at the lower level when the supply current is high without substantial risk of a droop below the specified range of supply voltages. Similarly, the probable magnitude of a voltage spike decreases at lower supply currents, therefore the static supply voltage may be set at the higher level when the supply current is low without substantial risk of a spike above the specified range of supply voltages.

### BRIEF DESCRIPTION OF THE DRAWINGS

FIG. 1 is a block diagram of a system according to some embodiments.

FIG. 2 is a plot of power supply load lines according to some embodiments.

FIG. 3 is diagram of a process according to some embodiments.

FIG. 4 is a top view of a system according to some embodiments.

FIG. 5a is a plot of a supply voltage over time according to some embodiments.

FIG. 5b is a plot of a supply current over time according to some embodiments.

FIG. 6 is a top view of a system according to some embodiments.

FIG. 7a is a plot of a supply voltage over time according to some embodiments.

FIG. 7b is a plot of a supply current over time according to some embodiments.

### DETAILED DESCRIPTION

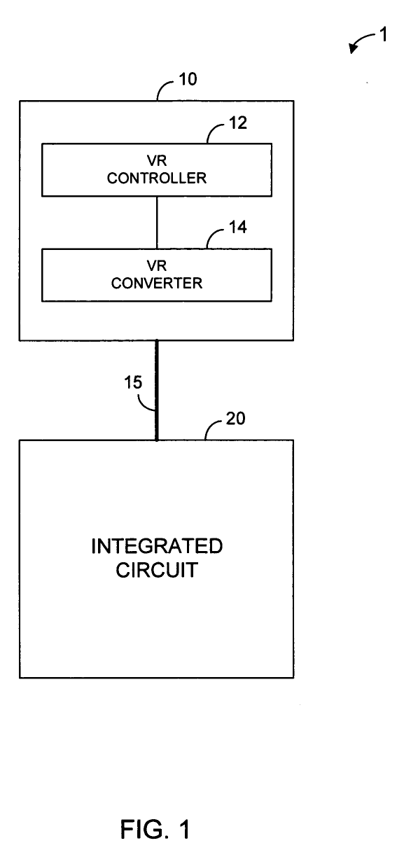

FIG. 1 is a block diagram of system 1 according to some embodiments. System 1 comprises voltage regulator 10, which in turn comprises voltage regulator controller 12 and voltage regulator converter 14. Bus 15 couples voltage regulator 10 to IC 20, which may comprise a microprocessor or any suitable IC. System 1 may be used in a computer motherboard or in any other platform according to some embodiments. For example, voltage regulator 10 may be implemented as a voltage regulator module that may be plugged coupled to a motherboard, as a voltage regulator “down” that is laid out on a motherboard, or in any other fashion.

Generally, voltage regulator 10 may comprise any currently- or hereafter-known device to provide a supply voltage having a particular value to IC 20. According to some embodiments, voltage regulator controller 12 transmits a control signal to voltage regulator converter 14. Voltage regulator converter 14 then adjusts the supply voltage, with the value of the supply voltage being controlled by the control signal. Voltage regulator converter 14 may comprise a Buck regulator or any other suitable device.

In some embodiments, voltage regulator 10 receives a load line signal representing a first supply voltage value associated with a first supply current value, and representing a second supply voltage value associated with a second supply current value. Voltage regulator 10 may then adjust a supply voltage having a value based at least in part on the load line signal.

The load line signal may be transmitted by IC 20 over bus 15 and received therefrom by voltage regulator 10 according to some embodiments. The load line signal may be a multi-bit signal transmitted serially and/or in parallel. The load line signal may represent the four above-mentioned values using any currently- or hereafter-known systems for representing data. For example, the signal may comprise an n-bit index to a value stored in a lookup table, with the value corresponding to the slope of a load line. The load line signal may also or alternatively comprise an n-bit code, with each of the 2ⁿ possible codes representing a step in a pre-specified range of impedance values. The load line signal may be received from another (unshown) source, and/or may comprise an electrical value (e.g. impedance, current, voltage) sensed by voltage regulator 10. In some embodiments, the load line signal represents a value of a resistor to which voltage regulator 10 is coupled.

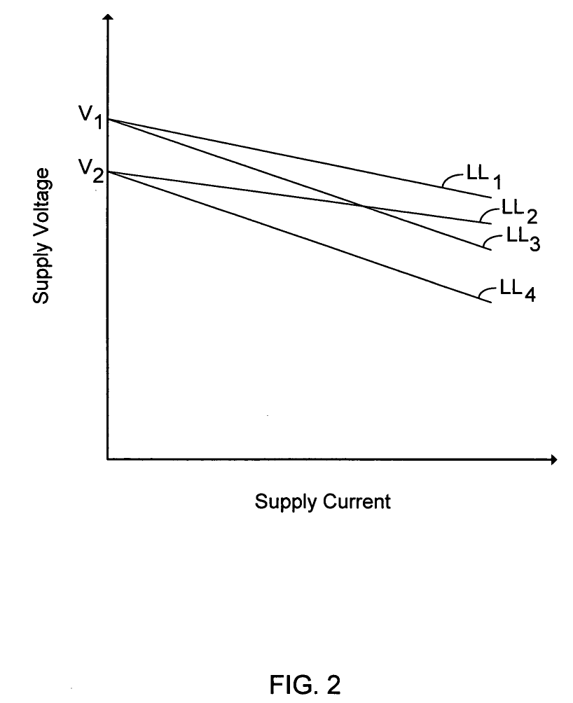

In some embodiments, the load line signal represents a line on a voltage vs. current coordinate system that includes the coordinates (first supply voltage value, first supply current value) and (second supply voltage value, second supply current value). FIG. 2 illustrates several of such lines according to some embodiments.

Lines LL₁ through LL₄ of FIG. 2 may represent power supply load lines. Each power supply load line indicates a static supply voltage to be supplied by voltage regulator 10 to IC 20 for a given supply current. Load lines LL₁ and LL₂ each intersect the voltage axis at V₁ but have different slopes. Load lines LL₃ and LL₄ each intersect the voltage axis at V₂ but also have different slopes. Voltages V₁ and V₂ represent static supply voltages in a no-load condition where the supply current is zero. The slopes of lines LL₁ through LL₄ may be considered negative impedances based on the relationships of voltage to current that they represent. Accordingly, the load line signal received by voltage regulator 10 may represent an impedance value.

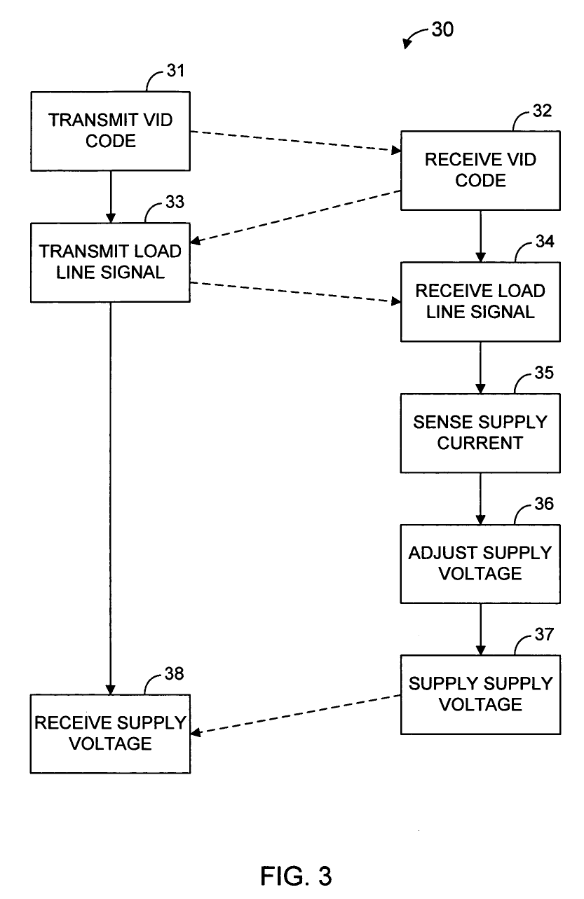

FIG. 3 is a flow diagram of process 30. Process 30 illustrates procedures executed by voltage regulator 10 and IC 20 according to some embodiments. The procedures may be executed by hardware and/or software.

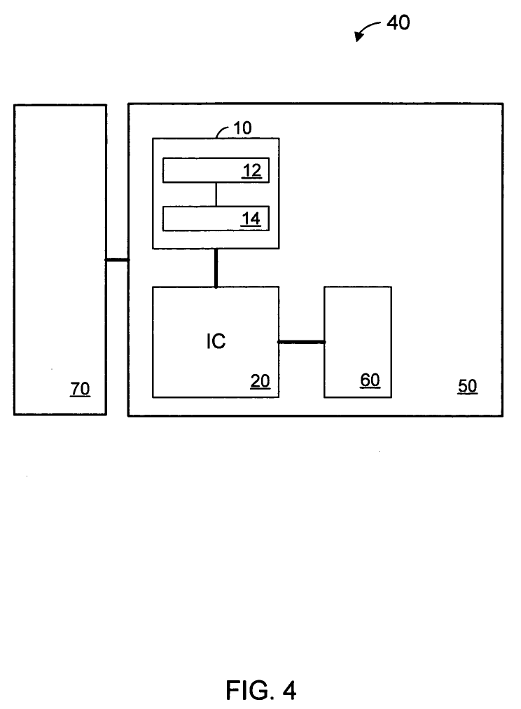

Initially, at 31, an IC transmits a Voltage IDentification (“VID”) code to a voltage regulator. FIG. 4 illustrates a system to execute process 30 according to some embodiments. System 40 includes voltage regulator 10, IC 20, motherboard 50, memory 60 and power supply 70. System 40 may comprise components of a desktop computing platform, and memory 60 may comprise any type of memory for storing data, such as a Single Data Rate Random Access Memory, a Double Data Rate Random Access Memory, or a Programmable Read Only Memory.

Motherboard 50 may include signal lines of bus 15. Accordingly, the VID code may be transmitted at 31 from IC 20 to voltage regulator 10 through motherboard 50. Similarly, motherboard 50 may route I/O signals between IC 20 and memory 60.

The VID code transmitted at 31 represents a value of a supply voltage to be transmitted to IC 20 by module 10 when the supply current is zero. Such a supply voltage corresponds to voltages V₁ or V₂ of FIG. 2. The VID code may comprise a numeric value that is equal to the no-load supply voltage value, an index to a supply voltage value stored in a lookup table, and/or any other representation of a voltage value. The VID code may be a multi-bit code transmitted serially and/or in parallel over bus 15. The VID code is received by voltage regulator 10 at 32. In some embodiments, voltage regulator controller 12 receives the VID code.

IC 20 then transmits a load line signal to voltage regulator 10 at 33. The first signal may represent a first supply voltage value associated with a first supply current value, and may represent a second supply voltage value associated with a second supply current value. As described above, the load line signal may comprise, for example, an impedance value, a load line slope, one or more sets of (voltage, current) coordinates, other types of information, and/or an index to a lookup table storing such information. The load line signal may be transmitted using the signal lines that were used to transmit the VID code at 31, or using one or more other signal lines. IC 20 may transmit the VID code after transmitting the load line signal or both may be transmitted substantially simultaneously.

The load line signal and the VID code may define a load line for IC 20. According to some embodiments, the VID code may provide the intersection of the load line with the voltage axis and the load line signal may provide an additional coordinate of or the slope of the load line. Voltage regulator 10 receives the first signal at 34.

Voltage regulator 10 senses the supply current at 35. The supply current may be sensed using any currently- or hereafter-known systems for sensing a supply current. Next, at 36, voltage regulator 10 adjusts a supply voltage to a particular value. The value of the adjusted supply voltage may be based at least in part on the first signal received at 34, and on the sensed supply current.

In some embodiments of 36, voltage regulator controller 12 transmits a control signal to voltage regulator converter 14, and voltage regulator converter 14 adjusts the supply voltage to an appropriate value. For example, voltage regulator controller 12 may determine a supply voltage value based on a load line defined by the first signal and based on the value of the supply current sensed at 35. Controller 12 may then transmit a control signal to control converter 14 to convert a DC voltage received from power supply 70 to a DC voltage of the determined value. Power supply 70 may also deliver power signals to motherboard 50 and/or to other unshown elements of a device in which system 40 is disposed.

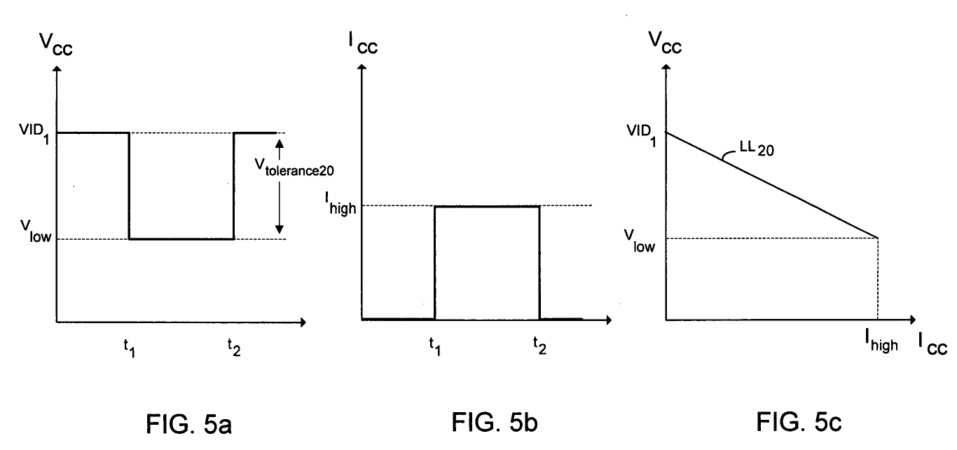

The generated supply voltage is supplied to IC 20 at 37, and is received by IC 20 at 38. In some embodiments, flow returns to 35 from 37 and continues as described above in order to periodically monitor the supply current and to update the supply voltage according to the load line. FIG. 5a is a plot of a supply voltage (V_{cc}) vs. time (t) to illustrate some embodiments of process 30. Value VID₁ indicates the no-load supply voltage value represented by the received VID code, time t₁ indicates a start-up time of IC 20, and voltage range V_{tolerance20} indicates an approved range of supply voltages for IC 20. FIG. 5b is a plot of a supply current (I_{cc}) vs. time (t). At time t1, the supply current drawn by IC 20 increases to I_{high}, and the increased supply current is sensed by module 10 at 35.

FIG. 5c is a plot of load line LL₂₀ according to some embodiments. Load line LL₂₀ reflects the VID code received at 32 and information provided by the first signal received at 34. In particular, load line LL₂₀ indicates that the supply voltage should be set to V_{low} in a case that the supply current is equal to I_{high}.

Therefore, based on the sensed current and on the first signal received at 34, module 10 adjusts a supply voltage having the value V_{low} at 36 and supplies the supply voltage to IC 20 at 37. Next, at time t₂, module 10 senses a decrease in the value of supply current I_{cc} to zero. Accordingly, based on the sensed current and on load line LL₂₀, module 10 adjusts a supply voltage having the value VID₁ at 36 and supplies the supply voltage to IC 20 at 37.

As shown in FIG. 5a, the value V_{low} corresponds to a supply voltage droop caused by the increased supply current and to a lowest supply voltage with which IC 20 is designed to operate. Similarly, the value VID₁ corresponds to a supply voltage spike caused by a decrease in supply current and to a highest supply voltage with which IC 20 is designed to operate. Such an arrangement allows a significant portion of voltage range V_{tolerance20} to be used for addressing supply voltage droops and spikes. System 40 may therefore require less bulk capacitance to address supply voltage droops and spikes than other systems.

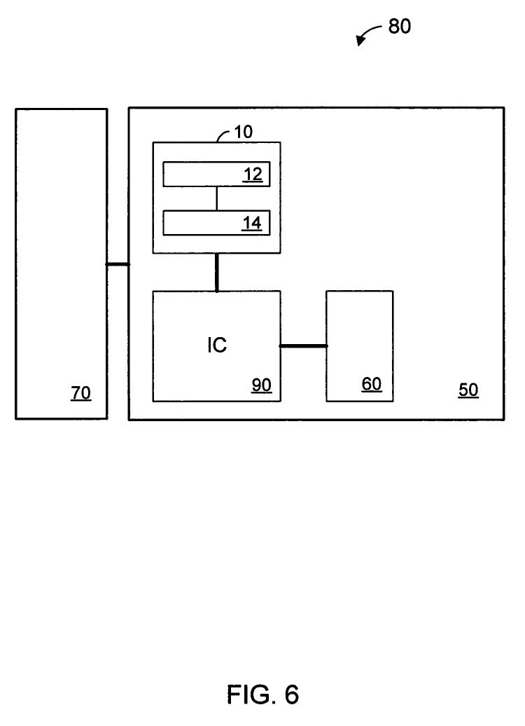

Some embodiments of process 30 may allow voltage regulator 10 to receive a second VID code and/or a second load line signal that define a new load line, and to update the supply voltage based on the new load line. As an example of one of these embodiments, FIG. 6 illustrates system 80, which may be identical to system 40 but with IC 20 having been replaced with IC 90. It will be assumed that process 30 returns to 31 after IC 20 is replaced with IC 90.

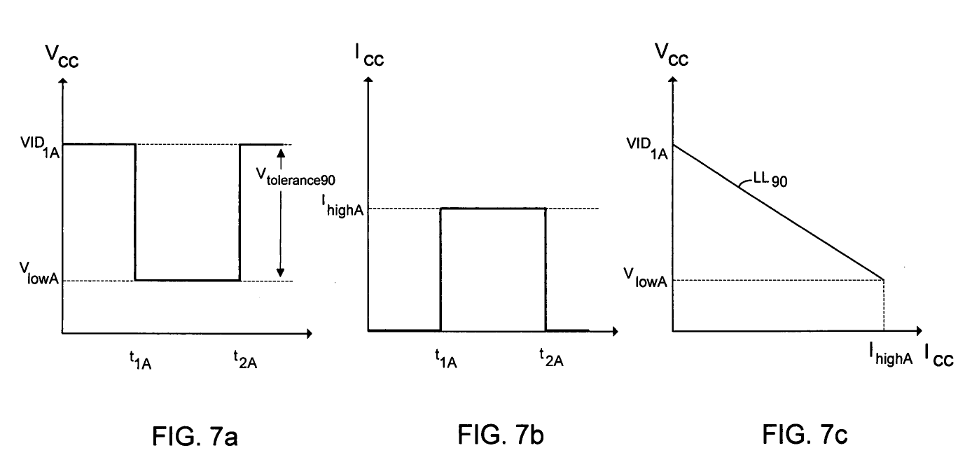

FIG. 7a is a plot of a supply voltage (V_{cc}) vs. time (t) for system 80. Value VID_{1A} indicates the no-load supply voltage value represented by a VID code received from IC 90 at 32, time t_{1A} indicates a start-up time of IC 90, and voltage range V_{tolerance90} indicates an approved range of supply voltages for IC 90. IC 90 may offer slower performance that IC 20, in which case V_{tolerance90} is greater than V_{tolerance20} of FIG. 5a. FIG. 7b is a plot of a supply current (I_{cc}) vs. time (t) for system 80. At time t_{1A}, the supply current drawn by IC 20 increases to I_{highA}, and the increased supply current is sensed by module 10 at 35.

FIG. 7c is a plot of load line LL₉₀ according to some embodiments. Load line LL₉₀ reflects the VID code received from IC 90 at 32 and information provided by the second signal received from IC 90 at 34. Load line LL₉₀ indicates that the supply voltage should be set to V_{lowA} in a case that the supply current is equal to I_{highA}.

Therefore, based on the sensed current and on the second signal received from IC 90 at 34, module 10 adjusts a supply voltage having the value V_{lowA} at 36 and supplies the supply voltage to IC 90 at 37. At time t_{2A}, module 10 senses a decrease in the value of supply current I_{cc} to zero. Therefore, based on the sensed current and on load line LL₉₀, module 10 adjusts a supply voltage having the value VID_{1A} at 36 and supplies the supply voltage to IC 90 at 37.

Similarly to FIG. 5a, FIG. 7a shows that the value V_{lowA} corresponds to a supply voltage droop caused by an increased supply current at time t_{1A}, and also corresponds to a lowest supply voltage with which IC 90 is designed to operate. The value VID_{1A} similarly corresponds to a supply voltage spike caused by a decrease in supply current and to a highest supply voltage with which IC 90 is designed to operate. A significant portion of voltage range V_{toleance90} may therefore be used for addressing supply voltage droops and spikes. System 80 may therefore require less bulk capacitance to address supply voltage droops and spikes than another system in which IC 20 is replaced with IC 90.

The several embodiments described herein are solely for the purpose of illustration. Some embodiments may include any currently or hereafter-known versions of the elements described herein. Therefore, persons skilled in the art will recognize from this description that other embodiments may be practiced with various modifications and alterations.

1. An apparatus comprising:
a first device to receive a first signal representing a first supply voltage value associated with a first supply current value, and representing a second supply voltage value associated with a second supply current value.

2. An apparatus according to claim 1, wherein the first signal represents an impedance value.

3. An apparatus according to claim 1, the first device to adjust a supply voltage to a value based at least in part on the first signal.

4. An apparatus according to claim 3, the first device comprising:
a voltage regulator converter to generate the supply voltage; and
a voltage regulator controller to receive the first signal and to transmit a control signal to the voltage regulator converter, the control signal to control the value of the supply voltage.

5. An apparatus according to claim 3, further comprising:
a second device to transmit the first signal and to receive the supply voltage.

6. An apparatus according to claim 5, wherein the second device comprises an integrated circuit.

7. An apparatus according to claim 3, wherein the supply voltage is associated with a supply current, wherein the first supply voltage value and the first supply current value define a first coordinate of a voltage vs. current coordinate system, wherein the second supply voltage value and the second supply current value define a second coordinate of the voltage vs. current coordinate system, wherein the first coordinate and the second coordinate define a line, wherein the value of the supply voltage and a value of the supply current define a third coordinate, and wherein the line substantially comprises the third coordinate.

8. An apparatus according to claim 1, wherein the first signal represents a slope of a power supply load line.

9. An apparatus comprising:
a first device to transmit a first signal representing a first supply voltage value associated with a first supply current value, and representing a second supply voltage value associated with a second supply current value.

10. An apparatus according to claim 9, wherein the first signal represents an impedance value.

11. An apparatus according to claim 9, wherein the first signal represents a slope of a power supply load line.

12. An apparatus according to claim 9, the first device to receive a supply voltage having a value based at least in part on the first signal.

13. An apparatus according to claim 12, wherein the supply voltage is associated with a supply current, wherein the first supply voltage value and the first supply current value define a first coordinate of a voltage vs. current coordinate system, wherein the second supply voltage value and the second supply current value define a second coordinate of the voltage vs. current coordinate system, wherein the first coordinate and the second coordinate define a line, wherein the value of the supply voltage and a value of the supply current define a third coordinate, and wherein the line substantially comprises the third coordinate.

14. An apparatus according to claim 13, the first device to transmit the first signal to a second device and to receive the supply voltage from the second device.

15. An apparatus according to claim 9, wherein the second device comprises an integrated circuit.

16. A method comprising:
receiving a first signal representing a first supply voltage value associated with a first supply current value, and representing a second supply voltage value associated with a second supply current value.

17. A method according to claim 16, wherein the first signal represents an impedance value.

18. A method according to claim 16, further comprising:
adjusting a supply voltage to a value based at least in part on the first signal.

19. A method according to claim 18, wherein generating the supply voltage signal comprises:
receiving the first signal;
determining the value of the supply voltage based at least in part on the first signal; and
transmitting a control signal to control a voltage regulator converter to generate the supply voltage.

20. A method according to claim 18, wherein the supply voltage is associated with a supply current, wherein the first supply voltage value and the first supply current value define a first coordinate of a voltage vs. current coordinate system, wherein the second supply voltage value and the second supply current value define a second coordinate of the voltage vs. current coordinate system, wherein the first coordinate and the second coordinate define a line, wherein the value of the supply voltage and a value of the supply current define a third coordinate, and wherein the line substantially comprises the third coordinate.

21. A method according to claim 16, wherein the first signal represents a slope of a power supply load line.

22. A method according to claim 16, further comprising:
adjusting a supply voltage having a value based at least in part on the first signal; and
receiving a second signal representing a third supply voltage value associated with the first supply current value, and representing a fourth supply voltage value associated with the second supply current value.

23. A method according to claim 22, wherein the second signal represents a second impedance value.

24. A method according to claim 22, wherein the second signal represents a slope of a second power supply load line.

25. A method according to claim 22, further comprising:
adjusting the supply voltage to a second value based at least in part on the second signal.

26. A method according to claim 25, wherein the second supply voltage is associated with a second supply current, wherein the third supply voltage value and the first supply current value define a first coordinate of a voltage vs. current coordinate system, wherein the fourth supply voltage value and the second supply current value define a second coordinate of the voltage vs. current coordinate system, wherein the first coordinate and the second coordinate define a line, wherein the value of the second supply voltage and a value of the second supply current define a third coordinate, and wherein the line substantially comprises the third coordinate.

27. A method comprising:
transmitting a first signal representing a first supply voltage value associated with a first supply current value, and representing a second supply voltage value associated with a second supply current value.

28. A method according to claim 27, wherein the first signal represents an impedance value.

29. A method according to claim 27, wherein the first signal represents a slope of a power supply load line.

30. A method according to claim 27, further comprising:
receiving a supply voltage having a value based at least in part on the first signal.

31. A method according to claim 30, wherein the supply voltage is associated with a supply current, wherein the first supply voltage value and the first supply current value define a first coordinate of a voltage vs. current coordinate system, wherein the second supply voltage value and the second supply current value define a second coordinate of the voltage vs. current coordinate system, wherein the first coordinate and the second coordinate define a line, wherein the value of the supply voltage and a value of the supply current define a third coordinate, and wherein the line substantially comprises the third coordinate.

32. A method according to claim 30, wherein transmitting the first signal comprises transmitting the first signal to a first device, and wherein receiving the supply voltage comprises receiving the supply voltage from the first device.

33. A system comprising:
a microprocessor to transmit a first signal representing a first supply voltage value associated with a first supply current value, and representing a second supply voltage value associated with a second supply current value;
a voltage regulator to receive the first signal; and
a double data rate memory electrically coupled to the microprocessor.

34. A system according to claim 33, wherein the first signal represents an impedance value.

35. A system according to claim 33, wherein the first signal represents a slope of a power supply load line.

36. A system according to claim 33, the voltage regulator to adjust a supply voltage to a value based at least in part on the first signal.

37. A system according to claim 36, the voltage regulator comprising:
a voltage regulator converter to generate the supply voltage; and
a voltage regulator controller to receive the first signal and to transmit a control signal to the voltage regulator converter, the control signal to control the value of the supply voltage.

38. A system according to claim 36, wherein the supply voltage is associated with a supply current, wherein the first supply voltage value and the first supply current value define a first coordinate of a voltage vs. current coordinate system, wherein the second supply voltage value and the second supply current value define a second coordinate of the voltage vs. current coordinate system, wherein the first coordinate and the second coordinate define a line, wherein the value of the supply voltage and a value of the supply current define a third coordinate, and wherein the line substantially comprises the third coordinate.
